(19) United States
(12) Patent Application Publication
(10) Pub. No.: US 2007/0240198 A1
(43) Pub. Date: Oct. 11, 2007

(54) Smart site-management system

(75) Inventors: Ilan Kander, St. Raanana (IL); Lawrence Shertz, Modi'in (IL)

Correspondence Address: DR. MARK FRIEDMAN LTD.;C/O Bill Polkinghorn, 9003 Florin Way, Upper Marlboro, MD, 20772, US

(73) Assignee: SUPERCOM LTD.

(21) Appl. No.: 11/397,580

(22) Filed: Apr. 5, 2006

(51) Int. Cl. H04L 9/32

(52) U.S. Cl. 726/2

(57) ABSTRACT

The present invention teaches a system for site management, and more specifically, for disaster site management. The system incorporates a network backbone for communication in a rugged, weather-resistant, flexibly-deployable scheme for monitoring and maintaining access to site perimeters, and providing access to personnel arriving at the site, while maintaining accountability and security in all operational procedures of the system. The system includes smart cards which contain personnel credentials, including biometric indicators. Real-time enrollment and authorization of personnel can be performed on-site, both on-line and off-line. The system can also employ virtual fences, CCTV with motion detection, central alarm management, external network interoperability, and satellite network systems for broader system coverage.

### FIELD AND BACKGROUND OF THE INVENTION

The present invention relates to a system for site management, and more specifically, for disaster site management. The system incorporates a network backbone for communication in a flexibly-deployable scheme for monitoring and maintaining access to site perimeters, and providing access to personnel arriving at the site, while maintaining accountability and security in all operational procedures of the system.

Roles and responsibilities of today's emergency response personnel have become vastly more complicated in the last ten to fifteen years. Terrorism, on both a micro- and macro-level, has changed the landscape for emergency responders forever, as have natural disasters, like Hurricane Katrina. The availability of unconventional weapons, the public accountability associated with ground water contamination, and the containment of leaks in nuclear power plants are all phenomena that have contributed to making the world of the emergency response manager and field officer one in which well-coordinated and accountable responses to incidents, as well as disasters, are key to performing the job. The job today goes far beyond simple response, and requires the utmost in preparedness, planning, and accountability.

The events that occurred on what has become ominously referred to simply as “9/11” sharpened the focus on these requirements, and in many ways, has encouraged city, county, regional, state, and federal personnel to come together to the planning table for collaboration on common and coordinated procedures, techniques, and technologies in responding to incidents and disasters. Indeed, the Department of Homeland Security was developed in response to this need, as were the President's Directives on the Management of Domestic Incidents and National Preparedness, which ultimately became what is now known as National Incident Management System (NIMS) requirements. NIMS now provides a venue for a consistent nationwide approach for Federal, State, and local governments to work effectively and efficiently together.

Primary among these best practices is the ability to coordinate and integrate resources and personnel among all jurisdictions and agencies. Full implementation of NIMS requires complete coordination and integration of resources and personnel, which span across a host of organizations and agencies (e.g. E911, emergency operations centers, firefighters, police and sheriff's departments, etc.), to multiple jurisdictions (i.e. local, regional, state, and federal), and to different communities of interest (e.g. anti-terrorism taskforces, hazardous materials-handling taskforces, bomb- and explosives-handling groups, etc.). Indeed, multi-agency and jurisdictional coordination and consistency of best practice procedures is at the heart of the NIMS requirements.

The first step taken by many organizations is compliance with a consistent ICS (Incident Command System) approach. The very next challenge then becomes an accountability system, which provides a fast and accurate authorization of personnel from many agencies and jurisdictions, in an effective, consistent, secure, accurate, and on-site manner.

However, good accountability systems nowadays must provide more than on-site authorization of a credential. Public safety officials are responsible for the incident scene, and must protect it from further damage, danger, or contamination. Both public safety and liability are at risk. High impact incidents have become like crime scenes in that the integrity of the scene must be ensured and protected, with detailed records securely kept and archived.

Containing and controlling an incident site is a basic obligation of today's first responder, in a time when yellow crime scene tape and manual inspection of identification badges are not enough. NIMS guidelines provide oversight, but technology is required to support the efforts of local first responders.

All emergency managers need to adhere to best practices in responding to incidents, but first must address a variety of challenges. When multiple agency personnel arrive on a scene, they appear with a variety of identification sources and badges. They require immediate authorization, using a system that authenticates them on-site, regardless of their agency or jurisdictional affiliation. A uniform standard for personnel authentication is currently lacking in most emergency management organizations.

Furthermore, tracking of personnel including first responders, as well as the public, entering, leaving, and within the perimeter of a scene is almost impossible. Documenting that tracking is largely a manual operation at the present time, if performed at all.

In addition, securing the disaster site is also largely manual, and a function of manpower, electrical power, and communications. Power sources and communications infrastructure are often knocked out by the disaster itself, making “lockdown” of the site very difficult. Weather, hazards, and geographic barriers are inherent problems with high-impact incidents. These natural, geographic, physical, and urban impediments many times make a site almost impossible to secure and monitor.

Another factor to be dealt with is that remote organizations, like Emergency Operations Centers (EOCs), often have responsibility for deploying personnel and tracking events on-site, but they have little or no visibility to the situation on-site, and in some cases, little or no communications with local site personnel.

It would be desirable to have a suitable technology that would be weather- and disaster-proof, capable of securing multiple perimeters, and able to authorize personnel credentials for site entry and exit. Such a technology must be feature-rich, but designed for field-disaster use and require no external sources of power or communication.

Examples of prior art systems are disclosed in U.S. Pat. No. 5,596,652, 5,793,882, 6,761,312. These patents teach a system which uses a network to assign emergency personnel to designated sectors of a site. Sector designation and personnel assignment are determined by protocols based on site-specific information acquired by the system. The system further incorporates a triage priority capability into its design.

The prior art system only allows or denies access to the site based on comparison of information carried by the person with information stored in a database. It does not acquire credentials on-site, verify credentials with biometric information, or allow for on-site enrollment of personnel. These deficiencies are significant since accountability is a high priority. Furthermore, system operation design must not impede disaster relief efforts.

Another example of a prior art system is disclosed in U.S. Patent Publication No. 2004/0066276. This prior art system uses PDA (Personal Digital Assistant) devices that are wirelessly connected as a school hall-monitoring system. The capabilities of such as a design would not meet the integrity and accountability required for a system meant to securely manage access to a disaster site.

Another example of a prior art system is disclosed in U.S. Patent Publication No. 2004/0251304. This prior art system uses a site-management network with flexible deployability. This prior art system does not feature capabilities to integrate external networks into the system. This factor limits the utility of the prior art system because various agencies will invariably be operating on numerous existing systems. The advantage of the present invention is the ability to incorporate external systems into a whole network platform, while maintaining access accountability.

Another example of a prior art system is disclosed in U.S. Pat. No. 6,819,219. This patent teaches a biometric identification system coupled to a wireless network. This prior art device does not include means for rapidly and flexibly deploying the network at a site, nor does it include means for incorporating external networks, while maintaining access accountability.

Another example of a prior art system is the Motobridge system (available from Motorola Inc., 1301 E. Algonquin Rd., Schaumberg, Ill. 60196). This prior art system features a network design which allows for interoperability of external systems. However, it does not offer the integrity and accountability of “airspace access management” of the present invention. The term “airspace access management” is used here to mean a “channeled access” to the network by external requesters (i.e. systems) that is authorized according to personnel credential protocols (or in some cases, agency credential protocols). The term “channeled access” is used here to mean that access to the other parts (i.e. channels) of the network is limited by credential protocols.

While present technologies offer some of the elements of what has been described above, there is presently a need for a complete solution that offers a real-time, on-site, personnel database-management system coupled with a wide-area network for communication, and which also features capabilities for producing badges containing personnel credentials, and obtaining, assessing, and authenticating personnel credentials, while further providing capabilities for CCTV, video motion detection, virtual fencing, interoperability between radios and computers, external communication links, and central alarm management for all the sub-systems mentioned above.

### SUMMARY OF THE INVENTION

For the purpose of clarity, several terms are specifically defined for use within the context of this application. The term “badging” is used in this application to refer to the procedure of producing a badge containing a user's credentials. The terms LAN, PAN, WAN, and MAN stand for Local-Area Network, Proximity-Area Network, Wide-Area Network, and Metro-Area Network, respectively.

Several aspects of a Smart Disaster Site-Management System (hereinafter SmartDSMS), and more generally, a Smart Site-Management System (hereinafter SmartSMS), are described below.

It is therefore the objective of the present invention to disclose a system for site-perimeter management, authorization, and accountability for emergency personnel.

It is further the objective of the present invention to disclose a system with on-site enrollment capabilities for biometric authentication and instant production of smart card credentials.

It is still further the objective of the present invention to disclose a self-contained wireless network, which tracks ingress and egress of credentialed personnel, operating at 900 MHz, at the frequency of the emergency agency's choice, or at frequencies of any other network backbone technology (licensed or non-licensed frequencies).

It is still further the objective of the present invention to disclose system featuring a zone authorization capability, which selectively allows or denies entrance to specified zones within the incident site.

It is still further the objective of the present invention to disclose a database-management system that contains, displays, and records various events regarding movement of credentialed personnel.

It is still further the objective of the present invention to disclose a system featuring a remote view of command-center transactions via network-connected clients (such as EOC staff, or Federal or State officials).

It is still further the objective of the present invention to disclose a rugged, weather-proof system platform that provides its own power and communications in “blackout” conditions.

It is still further the objective of the present invention to disclose a system featuring a uniquely-flexible repeater-based topology that overcomes physical and geographic barriers, which otherwise limit most wireless communication systems.

It is still further the objective of the present invention to disclose a SmartDSMS that combines wireless communications, authentication, badging, and database management for a best-of-breed accountability solution featuring: portable, contactless card and biometric readers; a modular system of tripod-mounted wireless antennas; a portable enrollment station; smart card badges; and a database-management system with real-time operations both on-line and off-line.

Therefore, according to the present invention, there is provided for the first time a system for monitoring and controlling access of an individual to a site perimeter, the system including: (a) an identification card for the individual, the identification card having: (i) at least one printed display credential of the individual; and (ii) a unique set of encoded credentials for identifying the individual exclusively; (b) a data interface mechanism for obtaining the unique set of encoded credentials from the identification card, the data interface mechanism configured to obtain at least one verification credential from the individual; (c) a host computer for storing a plurality of the unique set of encoded credentials in a database, the host computer configured to verify a match between at least one verification credential and at least one encoded credential of the unique set of encoded credentials; and (d) at least one base transmission mechanism for transmitting the unique set of encoded credentials from the data interface mechanism to the host computer and to at least one remote transmission mechanism, whereby the system is mobile, rugged, weather-resistant, and quickly-deployable.

Preferably, the identification card includes at least one item selected from the group consisting of a contact chip, a contactless chip, an RFID tag and a magnetic stripe.

Preferably, at least one printed display credential includes at least one item selected from the group consisting of: a barcode, a unique card serial number, a photograph, personal credentials, and a signature.

Preferably, the unique set of encoded credentials is encoded in at least one device selected from the group consisting of: a contact chip, a contactless chip, an RFID tag, a magnetic stripe, and a barcode.

Preferably, the unique set of encoded credentials includes at least one item selected from the group consisting of: a fingerprint biometric marker, hand-dimension biometric marker, a retinal biometric marker, a voiceprint biometric marker, a facial biometric marker, a unique card serial number, a photograph, personal credentials, a PIN, and a signature.

Preferably, the data interface mechanism includes at least one item selected from the group consisting of: a printer, an optical scanner, a magnetic stripe scanner, a magnetic stripe encoder, a barcode scanner, a biometric marker reader, a fingerprint scanner, an RFID tag reader, an RFID tag encoder, a display unit, an interface keypad, a microprocessor, a memory, a database, a communication interface, a buzzer, a fan, a power source, and indicator lights.

Preferably, the data interface mechanism is configured to verify a match between at least one verification credential and at least one encoded credential when the host computer is off-line.

Preferably, at least one verification credential is at least one item selected from the group consisting of: a fingerprint biometric marker, hand-dimension biometric marker, a retinal biometric marker, a voiceprint biometric marker, a facial biometric marker, a unique card serial number, a photograph, personal credentials, and a signature.

Preferably, the host computer is located remotely from the data interface mechanism.

Preferably, the host computer is configured to be accessed only by an authorized individual.

Preferably, the host computer is configured to authorize communicational access with the system to the individual only upon positive verification of the match between at least one verification credential and at least one encoded credential of the unique set of encoded credentials.

Preferably, the host computer is configured to maintain a record of transaction details of each the identification card that is read by the data interface mechanism.

Preferably, the host computer includes an alarm management system for monitoring alarms from at least one monitoring sub-system.

Most preferably, at least one monitoring sub-system is at least one system selected from the group consisting of: the data interface mechanism, a closed-circuit television (CCTV) system, a video motion-detection system, and a virtual fence system.

Preferably, the plurality of the unique set of encoded credentials is configured to be accessed only by an authorized individual.

Preferably, a copy of the database is located on the data interface mechanism, the copy periodically updated from the host computer when the host computer is on-line.

Most preferably, the copy is configured to periodically update the database on the host computer when the host computer is on-line.

Preferably, at least one encoded credential of the unique set of encoded credentials includes at least one item selected from the group consisting of: a fingerprint biometric marker, hand-dimension biometric marker, a retinal biometric marker, a voiceprint biometric marker, a facial biometric marker, a unique card serial number, a photograph, personal credentials, and a signature.

Preferably, at least one base transmission mechanism is configured to transmit at least one item selected from the group consisting of: a data transmission, a voice transmission, an audio transmission, and a video transmission.

Preferably, at least one base transmission mechanism is configured to operate using at least one selected from the group consisting of: telephone modem protocols, 802.11a LAN protocols, 802.11b LAN protocols, 802.11g LAN protocols, 802.15 PAN protocols, 802.16 WAN protocols, 802.16 MAN protocols, GPRS protocols, satellite protocols, cable protocols, two-way radio protocols, and direct cable protocols.

Preferably, at least one base transmission mechanism includes at least one external network transmission mechanism.

Most preferably, at least one external network transmission mechanism includes at least one device selected from the group consisting of: a network connection, a radio transceiver, and a computer.

Most preferably, the external network transmission mechanism is located remotely to at least one base transmission mechanism.

Preferably, at least one remote transmission mechanism is configured to operate using at least one selected from the group consisting of: telephone modem protocols, 802.11a LAN protocols, 802.11b LAN protocols, 802.11g LAN protocols, 802.15 PAN protocols, 802.16 WAN protocols, 802.16 MAN protocols, GPRS protocols, satellite protocols, cable protocols, two-way radio protocols, and direct cable protocols.

Preferably, at least one remote transmission mechanism includes at least one external network transmission mechanism.

Most preferably, at least one external network transmission mechanism includes at least one device selected from the group consisting of: a network connection, a two-ray radio transceiver, and a computer.

Most preferably, the external network transmission mechanism is located remotely to at least one remote transmission mechanism.

Preferably, the system also includes: (e) at least one power generation area for providing power to the host computer, and for recharging batteries and mobile devices.

Preferably, the system also includes: (e) at least one virtual fence system for detecting physical breeches of the site perimeter.

Preferably, the system also includes: (e) at least one virtual curtain system for detecting physical breeches of the site perimeter.

Preferably, the system also includes: (e) at least one virtual dome system for detecting physical breeches of the site perimeter.

Preferably, the system also includes: (e) at least one closed-circuit television (CCTV) system for detecting physical breeches and environmental conditions of the site perimeter.

Most preferably, at least one CCTV system includes a video motion-detection system.

Preferably, the system also includes: (e) at least one enrollment area for enrolling the individual into the database of the host computer and issuing the identification card, at least one enrollment area located remotely from the host computer, at least one enrollment area communicationally connected to at least one remote transmission mechanism.

These and further embodiments will be apparent from the detailed description and examples that follow.

### BRIEF DESCRIPTION OF THE DRAWINGS

The invention is herein described, by way of example only, with reference to the accompanying drawings, wherein:

FIG. 1 shows a simplified block diagram of a system topology for a SmartDSMS, according to the present invention;

FIG. 2 shows a simplified diagram of a command center stand, according to the present invention;

FIG. 3 shows a simplified diagram of a DynaGate stand with a DynaGate suitcase, according to the present invention;

FIG. 4 shows a simplified diagram of a DynaGate suitcase with its control panel and connection ports, according to the present invention;

FIG. 5 shows a simplified diagram of a DynaGate suitcase with its connection ports in use, according to the present invention;

FIG. 6 shows a simplified block diagram of an enrollment area and station of a SmartDSMS, according to the present invention;

FIG. 7 shows a simplified flowchart of the enrollment process and card issuance of a SmartDSMS, according to the present invention;

FIG. 8 shows a simplified flowchart of the authentication process of a SmartDSMS, according to the present invention;

FIG. 9 shows a simplified block diagram of a system topology for a SmartDSMS which allows access to external networks, according to the present invention.

### DESCRIPTION OF THE PREFERRED EMBODIMENTS

The present invention relates to systems for SmartDSMS and SmartSMS. The principles and operation of a SmartDSMS and SmartSMS, according to the present invention, may be better understood with reference to the drawings and the accompanying description.

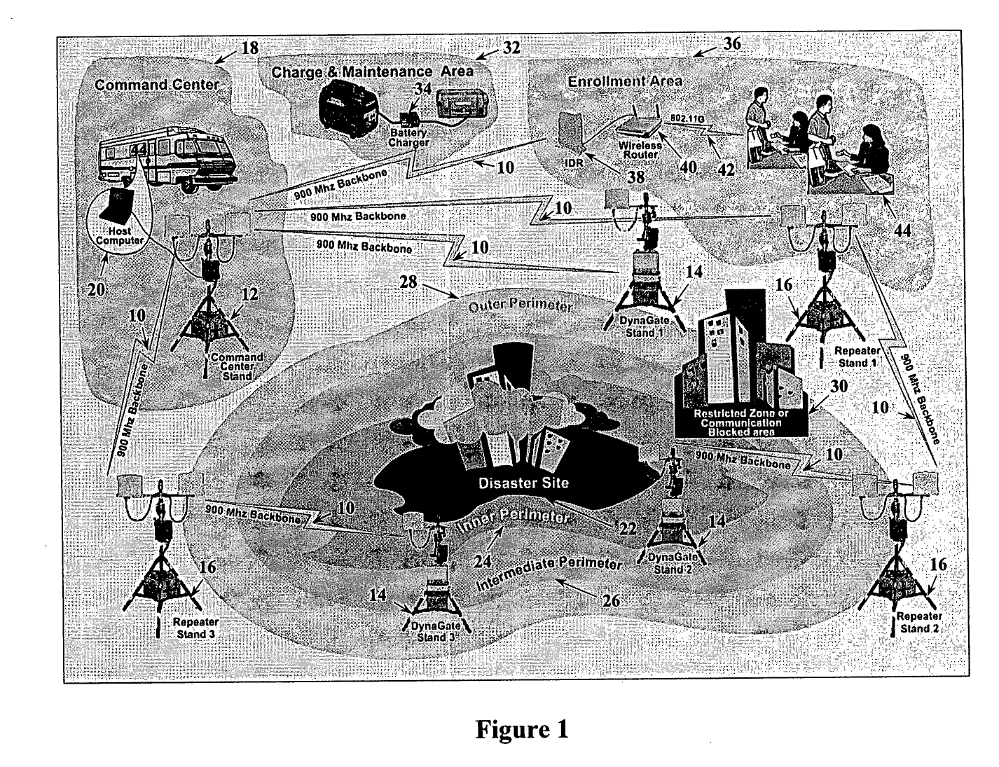

Referring now to the drawings, FIG. 1 shows a simplified block diagram of a system topology for a SmartDSMS, according to some embodiments of the present invention. A 900 MHz wireless network backbone 10 is established by a command center stand 12, DynaGate stands 14, and repeater stands 16. Network backbone 10 is an IP-based (i.e. Internet Protocol), point-to-multi-point network for transmitting data and bridging long distances that cannot be covered by limited-coverage networks. A command center 18 houses a host computer 20 where accountability databases are located (not shown). Network backbone 10 can easily be configured to operate on frequencies other than 900 MHz as well.

Site management of a disaster site 22 is established and maintained by an inner perimeter 24, an intermediate perimeter 26, and an outer perimeter 28, which can be scaled to meet site needs by adding repeater stands 16. A restricted zone or communication-blocked area 30 can be circumvented by the addition of repeater stands 16. Additional security zones (not shown) may be established within outside perimeter 28 by adding more DynaGate stands 14. DynaGate stands 14 may be configured as either dedicated entrance or exit stations, or can be configured as both a combined entrance and exit station.

A site survey must be conducted prior to the installation of the system in order to define the various security perimeters (i.e. inner perimeter 24, intermediate perimeter 26, and outer perimeter 28) and thus, the location of the equipment. The survey should determine optimum placement of the SmartDSMS equipment from a security perspective, as well as network topology functionality.

The number of security perimeters and the number of entrances and/or exits will determine how many DynaGates Stands 14 need to be installed. The size and the topographical structure of disaster site 22, as well as obstacles within the security perimeters, will determine how many repeater stations 16 need to be installed to ensure connectivity of network backbone 10 at the locations required throughout disaster site 22. When conducting the site survey, obstacles (such as buildings, trees, fences, electrical wires, and hills) that could block the line-of-sight between the communication devices must be noted.

The stands (i.e. command center stand 12, DynaGate stands 14, and repeater stands 16) should be strategically placed while ensuring optimized line-of-sight between the communication devices in order to achieve reliable network communication between the stands and command center 18 where host computer 20 is located.

FIG. 1 also shows a charge & maintenance area 32 is used to supply power to the components of the system (via gas-powered generators), swap and charge equipment using battery charger 34, and service field equipment on-site. An optional enrollment area 36 allows for on-site enrollment of personnel, with complete facilities for enrollment and card issuance. Enrollment area 36 features an IDR 38 (Indoor Data Radio), wireless router 40 with standard communication protocol 42, and enrollment stations 44. Communication protocol 42 can be 802.11b, 802.11g, GPRS, and Bluetooth standards.

Once the installation locations are defined, marked, and registered, the equipment for command center 18, enrollment area 36, command center stand 12, DynaGate stands 14, and repeater stands 16 can be safely transported, unpacked, assembled, and powered at their designated locations.

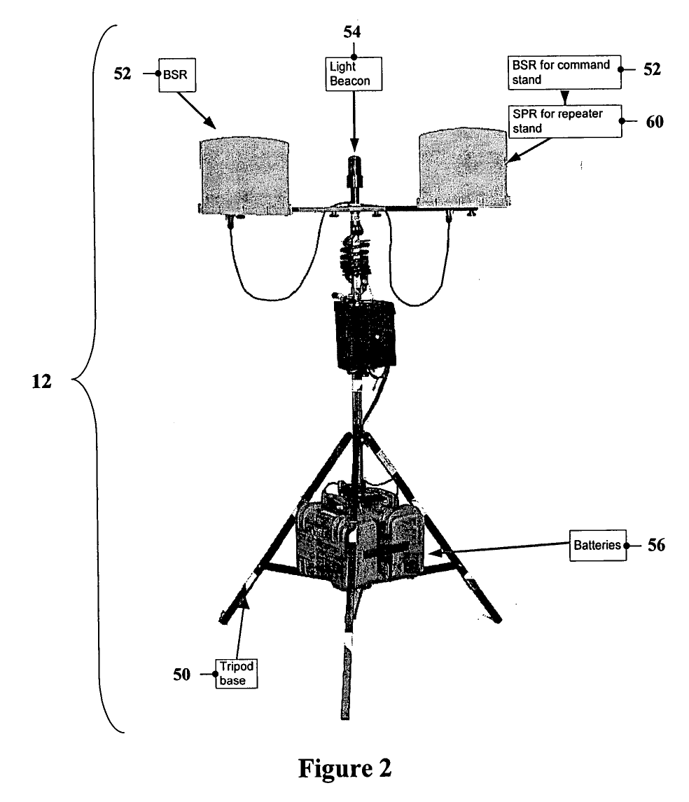

FIG. 2 shows a simplified diagram of command center stand 12. Command center stand 12 provides a focal point on-site for the communication links to the site perimeters, according to the present invention. Command center stand 12 features a tripod base 50, which houses, among other things: a BSR 52 (Base Station Radio) for communication over network backbone 10, a light beacon 54 for locating command Stand 12, and batteries 56. Batteries 56 contain one or two battery packs, allowing “hot swapping” for continuous operation, as long as the battery packs are recharged and replaced in a timely manner. In addition to the above items, command center stand 12 can also include another BSR 52 for an additional communication branch and/or network redundancy. In addition to the above items, repeater stands 16 also include an SPR 60 (Subscriber Premises Radio) for communication over network backbone 10.

The communication devices need to be positioned in such a way that BSR 52 on command center stand 12 or repeater stand 16 should always face SPR 60 on repeater stand 16 or DynaGate stand 14, since BSR 52 and SPR 60 are configured to operate directionally in order to reduce power consumption, extend range, and/or reduce reflection from objects. It is noted that, in preferred embodiments, omni-directional radios can be used as well.

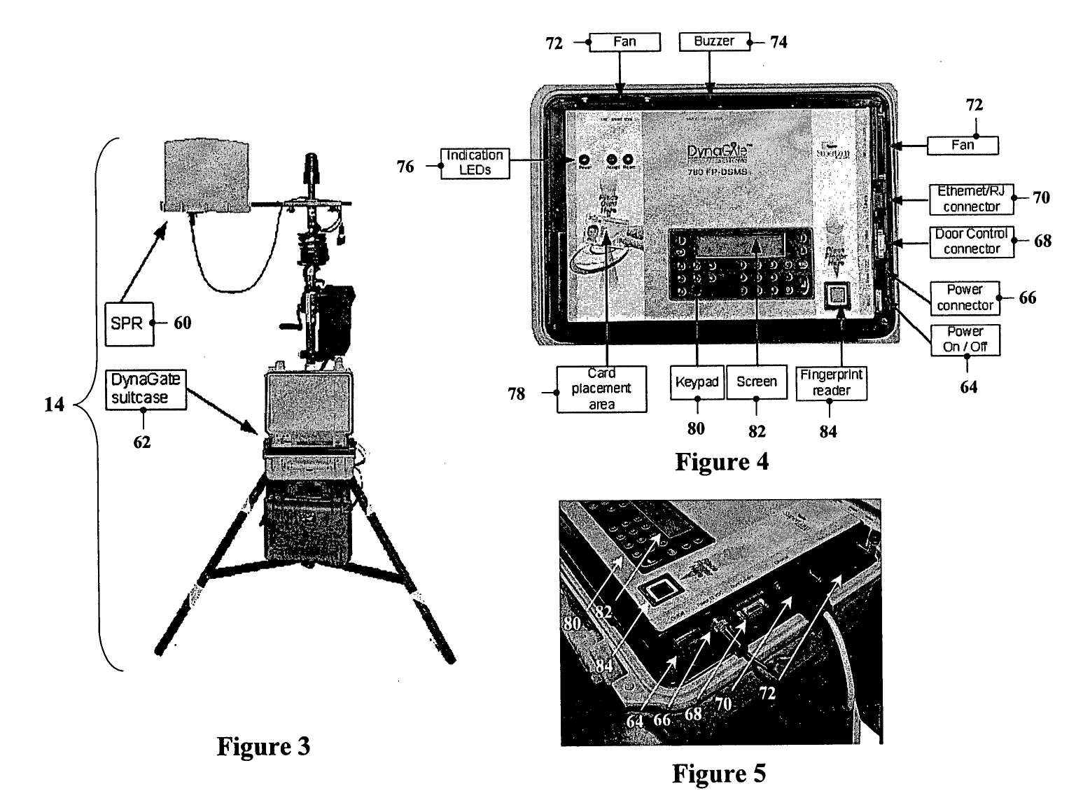

FIG. 3 shows a simplified diagram of a DynaGate stand 14 with a DynaGate suitcase 62, according to the present invention. Each DynaGate stands 14 serves as an access entry and exit control point. In contrast to command center stand 12, shown in FIG. 2, DynaGate stand 14 has an SPR 60 in place of BSR 52 on command center stand 12. FIG. 4 shows a simplified diagram of DynaGate suitcase 62 with its control panel and connection ports, according to the present invention. DynaGate suitcase 62 features: a power switch 64, a power connector 66, a door control connector 68, an Ethernet/RJ connector 70, fans 72, a buzzer 74, indication LEDs 76, card placement area 78, a keypad 80, a screen 82, and a fingerprint reader 84.

FIG. 5 shows a simplified diagram of DynaGate suitcase 62 with its connection ports in use, according to the present invention. DynaGate suitcase 62 is a remote-access control and authentication station that operates on-line or off-line. While DynaGate suitcase 62 is shown mounted on DynaGate stand 14, it can also be removed and transported. DynaGate suitcase 62 is used for permitting or denying individuals' entry and access to disaster site 22, and for providing real-time data on enrolled individuals' location within disaster site 22.

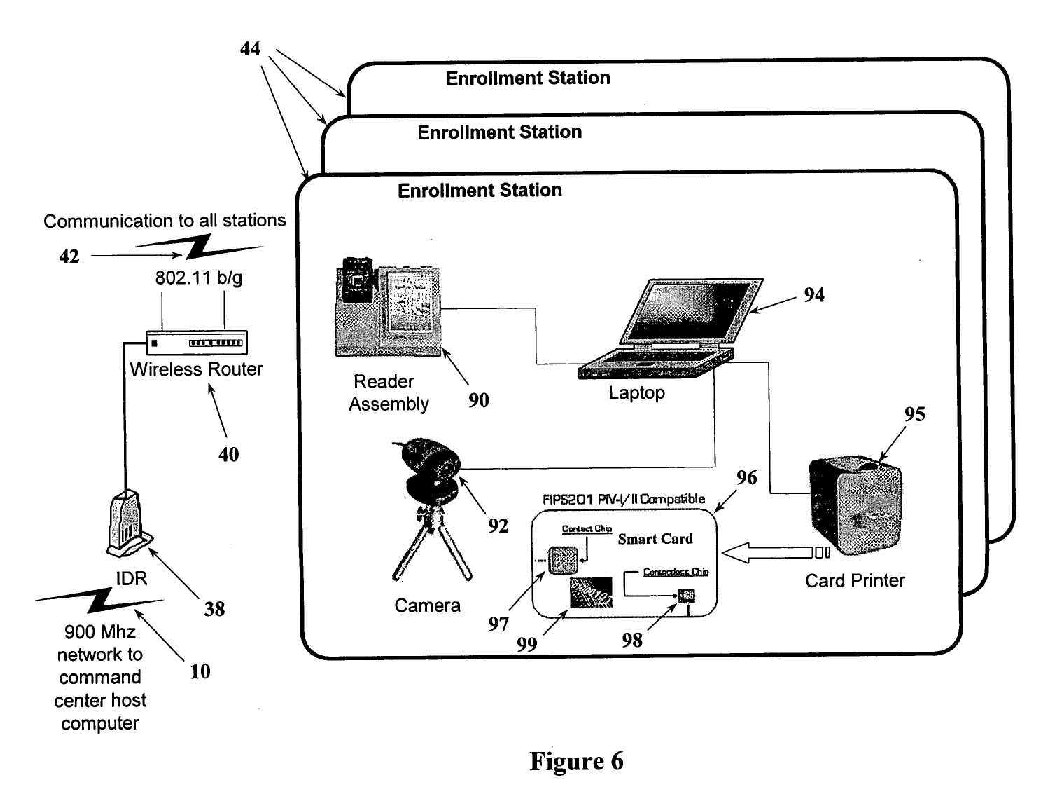

FIG. 6 shows a simplified block diagram of an enrollment area and station of a SmartDSMS, according to the present invention. Optional enrollment area 36 (shown in FIG. 1) features enrollment stations 44 for acquiring credentials and issuing badges. FIG. 6 shows the communication devices (i.e. network backbone 10, IDR 38, wireless router 40, and standard communication protocol 42) for enrollment area 36, and the components of enrollment stations 44. An individual's fingerprints and pictures are obtained by a reader assembly 90 and a camera 92, respectively. An enrollment computer 94 collects credential information, and uses a card printer 95 to issue a smart card 96.

It is noted that in preferred embodiments of the present invention, Smart card 96 contains a contact chip 97 and/or a contactless chip 98 (e.g. FIPS201 PIV-I/II compatible) to allow for multi-platform operability. Contact chip 97 and contactless chip 98 are electronic memory chips with or without CPU. Smart card 96 also contains multiple encoded regions 99 that can be read by a scanner on its surface (not shown) for retrieval of various data (e.g. “serial number” data, etc.). Among other things, encoded regions 99 can be barcodes, RFID tags, or magnetic stripes. Reader assembly 90 features the ability to write and read data to contact chip 97 and contactless chip 98, and scan encoded regions 99 of smart card 96. Smart card 96 serves as the individual's badge within the various perimeters, contains the individual's credential, and thus, limits the individual to only access areas and/or information which he has been authorized to access.

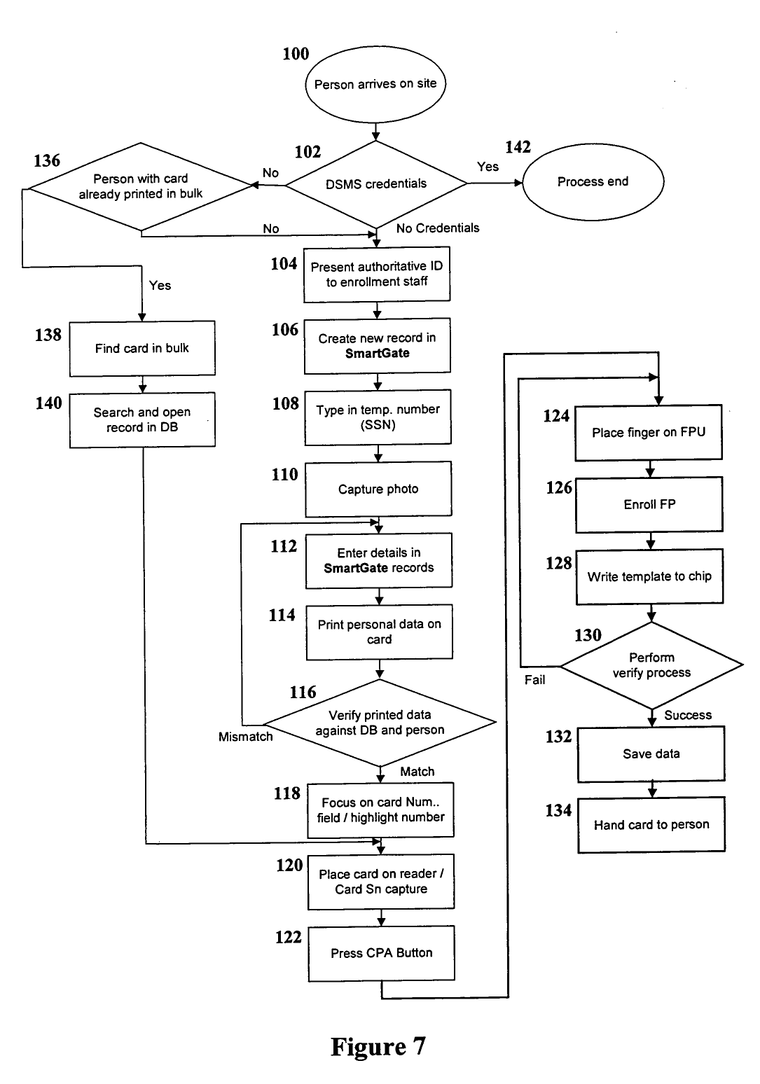

FIG. 7 shows a simplified flowchart of the enrollment process and card issuance of a SmartDSMS, according to the present invention. The SmartDSMS operates as follows. An individual arrives on-site (Block 100). The operator requests credentials (i.e. smart card 96) from the individual (Block 102). If the person has no credentials, he must be enrolled by the operator.

During enrollment, the individual must present valid authoritative identification to the operator (Block 104). The operator then does the following:
(1) Creates a new database record in enrollment computer 94 (Block 106).
(2) Assigns a system identification number, like a Social Security Number, to the individual (Block 108).
(3) Captures the individual's photograph using camera 92 (Block 110).
(4) Enrolls the individual by entering the required personal data into enrollment computer 94 (Block 112). The data to be captured is dictated by local agency policy.
(5) Prints smart card 96 via card printer 95 with the personal data and encoded regions 99 printed on the surface (Block 114), and inspects the card for a match before presenting it to the individual (Block 116). If there is a mismatch between the card details, database, and/or the individual, the database record is updated (Block 112).
(6) Orients smart card 96 on reader assembly 90 such that encoded regions 99, which include a unique serial number for each smart card 96, are accessible by the scanner component of reader assembly 90 (Block 118).
(7) Captures serial number of smart card 96 using reader assembly 90, and assigns it to the database record in enrollment computer 94 associated with smart card 96 (Block 120).
(8) Writes encoded data to contact chip 97 and/or contactless chip 98 of smart card 96 using reader assembly 90 (Block 122).
(9) Acquires fingerprint using reader assembly 90 (Block 124), and assigns it to the database record in enrollment computer 94 associated with smart card 96 (Block 126).
(10) Writes encoded fingerprint data (e.g. fingerprint image data or fingerprint minutiae data) to contact chip 97 and/or contactless chip 98 of smart card 96 using reader assembly 90 (Block 128).
(11) Verifies that encoded fingerprint data on smart card 96 is correct by reading the data from smart card 96 using reader assembly 90, and comparing it to data in the database record in enrollment computer 94 (Block 130). If the data does not match, the operator performs fingerprint acquisition again (Block 124).
(12) Saves data to the database record in enrollment computer 94 upon successful verification (Block 132).
(13) Transfers smart card 96 to individual (Block 134).

It is noted that at the initial stage of the enrollment process (Block 102), if the individual does not have his smart card 96, but was enrolled during a bulk enrollment period (Block 136), then the operator simply retrieves the individual's smart card from the bulk cards (Block 138). The operator then opens the individual's database record in enrollment computer 94 (Block 140), and continues with the enrollment process by capturing the serial number of the smart card (Block 120). Alternatively, if the individual has his smart card 96 upon arrival, the enrollment process terminates (Block 142). It is also noted that in preferred embodiments, the individual's credentials include a PIN (i.e. Personal Identification Number) which is chosen by the individual during the enrollment process (not shown).

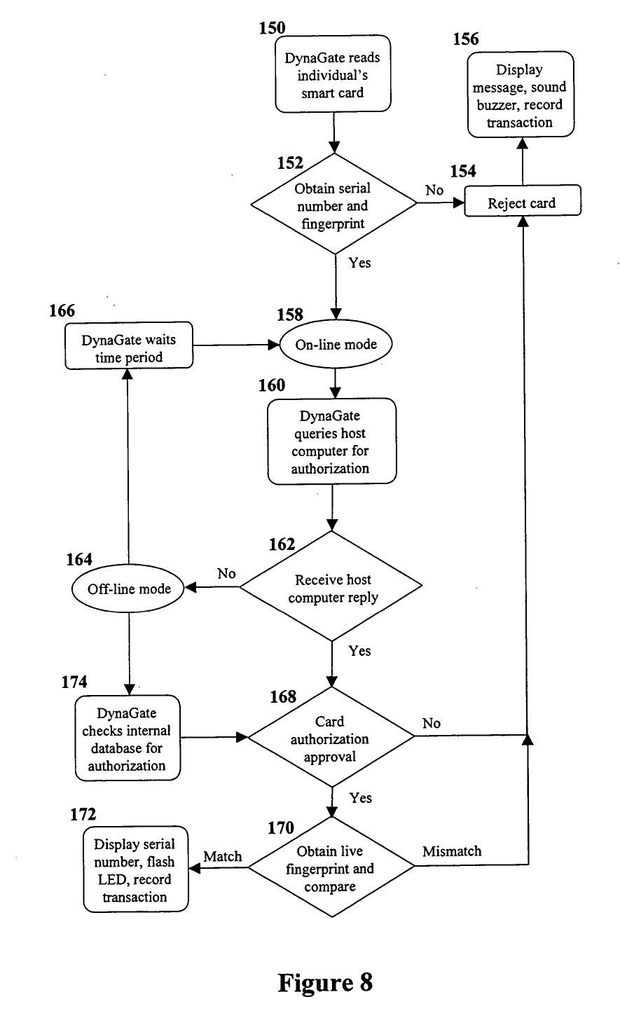

FIG. 8 shows a simplified flowchart of the authentication process of a SmartDSMS, according to the present invention. During on-line authentication, when an individual places his smart card 96 (FIG. 6) in card placement area 78 of DynaGate suitcase 62 and DynaGate stand 14 is on-line (FIGS. 3, 4, and 5), authentication is performed as follows:
(1) DynaGate suitcase 62 reads the serial number of smart card 96 and the fingerprint data stored on the card (Block 150 of FIG. 8). If it fails to read any of the data (Block 152), the card is rejected (Block 154). A proper message is displayed on screen 82 and buzzer 74 is sounded (Block 156).
(2) After reading the card data successfully, DynaGate suitcase 62 activates on-line mode (Block 158), sends a query with the individual's card details to host computer 20 of FIG. 1 (Block 160), and waits for authorization to accept or reject the card (Block 162). Data is transmitted from DynaGate stand 14 via SPR 60 to the nearest BSR 52 over network backbone 10 (either via a repeater stand 16 or directly to command center stand 12).
(3) If for any reason the reply is not received within a short amount of time (i.e. 5-10 seconds), DynaGate stand 14 switches to off-line mode (Block 164). In such a case, DynaGate stand 14 remains in off-line mode for every card that is subsequently presented within the next minute. After the one minute period (Block 166), DynaGate stand 14 automatically switches back to on-line mode (Block 158). When the next card is presented, DynaGate stand 14 will attempt to access host computer 20 again (Block 160). If it successfully accesses host computer 20, on-line mode is maintained. If not, DynaGate stand 14 reverts to off-line mode for another minute. Verification by host computer 20 determines whether the individual is or is not permitted to enter the site.
(4) Once DynaGate stand 14 receives the reply (Block 168), if smart card 96 is rejected (Block 154), a proper message is displayed on screen 82 and buzzer 74 is sounded (Block 156). If smart card 96 is accepted, the individual is asked to place his finger on fingerprint reader 84 for final biometric verification (Block 170). If the individual's live fingerprint data matches the data previously read from smart card 96, the card serial number is displayed, and indication LEDs 76 illuminate momentarily (Block 172). If not, the card is rejected (Block 154). A proper message is displayed on screen 82 and buzzer 74 is sounded (Block 156).
(5) The details of the authorization transaction are written to DynaGate suitcase 62 (Blocks 156 and 172), and immediately transferred to host computer 20. The list of transactions that are stored in the database on host computer 20 can be used to generate reports and alarms.

During off-line authentication, when an individual places his smart card 96 in card placement area 78 of DynaGate suitcase 62 and DynaGate stand 14 is off-line, no communication occurs between host computer 20 and DynaGate stand 14. Authentication is performed as follows:
(1) DynaGate suitcase 62 reads the serial number of smart card 96 and the fingerprint data stored on the card (Block 150 of FIG. 8). If it fails to read any of the data (Block 152), the card is rejected (Block 154). A proper message is displayed on screen 82 and buzzer 74 is sounded (Block 156).
(2) After reading the card data successfully, DynaGate suitcase 62 checks its internal database (Block 174) containing an internal permissions table (from the most recent update of the database from host computer 20) to determine whether smart card 96 should be accepted (Block 168). If the test results show that smart card 96 is rejected, a proper message is displayed on screen 82 and buzzer 74 is sounded (Block 156). If smart card 96 is accepted, the individual is asked to place his finger on fingerprint reader 84 for final biometric verification (Block 170). If the individual's live fingerprint data matches the data previously read from smart card 96, the card serial number is displayed, and indication LEDs 76 illuminate momentarily (Block 172). If not, the card is rejected (Block 154). A proper message is displayed on screen 82 buzzer 74 is sounded (Block 156). In preferred embodiments, a correct PIN entry via keypad 80 is also required for system access (not shown).
(3) The details of the authorization transaction are written to DynaGate suitcase 62 (Blocks 156 and 172), and transferred to host computer 20 when DynaGate stand 14 returns to on-line mode.

It is noted that in preferred embodiments of the present invention, “virtual fences” can be incorporated into the perimeter monitoring system, which can have their own communication link to network backbone 10, and can be self-powered. When these systems have their “fence” path interrupted, they automatically turn on video cameras which send data over IP to the command center. These components can utilize a laser-tracking system, for example. This feature adds the ability to track physical breeches of the perimeters in approximately 200 meter increments. Similarly, “virtual curtains” can be deployed with operating areas of approximately 200 meters by 5 meters. Finally, “virtual domes”, utilizing a rotating laser-tracking system (for example), can be deployed with operating volumes having a ground radius of approximately 200 meters and a dome height of 3 meters.

It is further noted that in preferred embodiments of the present invention, CCTV (closed-circuit television) systems can be incorporated into the perimeter monitoring system. This feature adds the ability to monitor physical breeches and environmental conditions of the perimeters. The CCTV system can be coupled with a video motion-detection system so as to allow it to work independently, and generate an alarm at the command center only when motion is detected in a predefined restricted zone. In this case, network backbone 10 will transmit the video signal as IP data to command center 18.

It is further noted that in preferred embodiments of the present invention, external networks, that can be allowed to access the system network, can be incorporated into the perimeter monitoring system, providing “airspace access management” (as defined above).

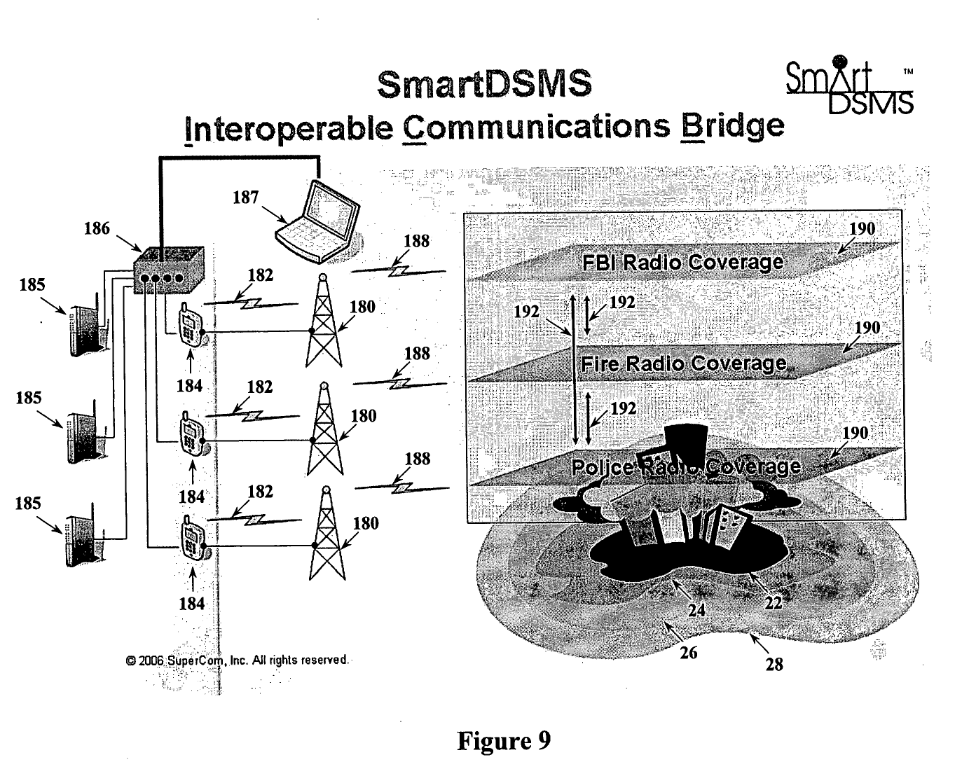

FIG. 9 shows a simplified block diagram of a system topology for a SmartDSMS which allows access to external networks, according to the present invention. Stands 180 can each be either command center stands 12, DynaGate stands 14, or repeater stands 16. However, stands 180 include additional transceivers (e.g. BSR 52 and SPR 60) set to transmit data to and from external networks 182. External networks 182 can be any type of system using two-way radio transceivers 184 that an external agency's personnel (e.g. FBI, fire, police, etc.) are equipped with. External networks 182 can also be news media servers, weather servers, and other information or data portals.

Client servers 185 convert voice and data transmissions to IP data, and vice versa. An interoperability bridge 186 communicationally connects one-to-many or many-to-many transceivers 184. A bridge computer 187 handles the routing of transmissions to and from external networks 182. It should be clarified that bridge 186 and transceivers 184 are located on each stand 180, according to preferred embodiments. It is noted that transceivers 184 can have messaging capabilities or can F be computers, in preferred embodiments. It is further noted that bridge 186 and transceivers 184 can be additionally mounted on suitable environmental landmarks (e.g. water towers, electrical towers, telephone poles, building rooftops, etc.), in preferred embodiments.

It is noted that in order for each external network 182 to communicate throughout the system, it is necessary for each stand 180 to have an additional transceiver for each external network 182. This enables extended network 188 to carry transmission from external networks 182 to various site perimeters (22, 24, 26, and 28). Extended network 188 is network backbone 10 with connectivity to external networks 182. Thus, agency coverages 190 are operative on-site with minimal activity required to configure the system. This also allows for inter-agency communications 192. As noted above, it is appreciated that agency coverages 190 can include voice and data communication.

It is noted that agency coverages 190 and inter-agency communications 192 are subject to the same authorization access protocols described above. Thus, the system provides “channeled access” (as defined above) to external networks 182, allowing agency personnel access only to the channels of the system that they have been authorized to access.

It is noted that the interoperability bridging described above can be performed in-band (i.e. a set of channels around a given transmission frequency), channel-to-channel, band-to-band in order to transmit data-to-voice and/or data-to-data. All transmissions (both data and voice) are converted to IP-based data streams, routed according to the protocol of client servers 185, and managed by several dispatch computers (not shown).

It is further noted that in preferred embodiments of the present invention, satellite network systems can be incorporated into the perimeter monitoring system, using a scheme similar to the one shown in FIG. 9. This feature adds the ability to communicate with a broader array of networks that can cross national borders. This feature provides a global communication means for PC, data, VOIP, video, and phone transmission, with all the access accountability features of the SmartDSMS described above.

Finally, it is further noted that while the description above refers to a SmartDSMS, a similar system and protocol can be deployed for a general SmartSMS, where the utility of the system is not exclusively disaster site management.

While the invention has been described with respect to a limited number of embodiments, it will be appreciated that many variations, modifications, and other applications of the invention may be made.

What is claimed is:

1. A system for monitoring and controlling access of an individual to a site perimeter, the system comprising:
(a) an identification card for the individual, said identification card having:
(i) at least one printed display credential of the individual; and
(ii) a unique set of encoded credentials for identifying the individual exclusively;
(b) a data interface mechanism for obtaining said unique set of encoded credentials from said identification card, said data interface mechanism configured to obtain at least one verification credential from the individual;
(c) a host computer for storing a plurality of said unique set of encoded credentials in a database, said host computer configured to verify a match between said at least one verification credential and at least one encoded credential of said unique set of encoded credentials; and
(d) at least one base transmission mechanism for transmitting said unique set of encoded credentials from said data interface mechanism to said host computer and to at least one remote transmission mechanism, whereby the system is mobile, rugged, weather-resistant, and quickly-deployable.

2. The system of claim 1, wherein said identification card includes at least one item selected from the group consisting of a contact chip, a contactless chip, an RFID tag and a magnetic stripe.

3. The system of claim 1, wherein said at least one printed display credential includes at least one item selected from the group consisting of: a barcode, a unique card serial number, a photograph, personal credentials, and a signature.

4. The system of claim 1, wherein said unique set of encoded credentials is encoded in at least one device selected from the group consisting of: a contact chip, a contactless chip, an RFID tag, a magnetic stripe, and a barcode.

5. The system of claim 1, wherein said unique set of encoded credentials includes at least one item selected from the group consisting of: a fingerprint biometric marker, hand-dimension biometric marker, a retinal biometric marker, a voiceprint biometric marker, a facial biometric marker, a unique card serial number, a photograph, personal credentials, a PIN, and a signature.

6. The system of claim 1, wherein said data interface mechanism includes at least one item selected from the group consisting of: a printer, an optical scanner, a magnetic stripe scanner, a magnetic stripe encoder, a barcode scanner, a biometric marker reader, a fingerprint scanner, an RFID tag reader, an RFID tag encoder, a display unit, an interface keypad, a microprocessor, a memory, a database, a communication interface, a buzzer, a fan, a power source, and indicator lights.

7. The system of claim 1, wherein said data interface mechanism is configured to verify a match between said at least one verification credential and at least one said encoded credential when said host computer is off-line.

8. The system of claim 1, wherein said at least one verification credential is at least one item selected from the group consisting of: a fingerprint biometric marker, hand-dimension biometric marker, a retinal biometric marker, a voiceprint biometric marker, a facial biometric marker, a unique card serial number, a photograph, personal credentials, and a signature.

9. The system of claim 1, wherein said host computer is located remotely from said data interface mechanism.

10. The system of claim 1, wherein said host computer is configured to be accessed only by an authorized individual.

11. The system of claim 1, wherein said host computer is configured to authorize communicational access with the system to the individual only upon positive verification of said match between said at least one verification credential and at least one encoded credential of said unique set of encoded credentials.

12. The system of claim 1, wherein said host computer is configured to maintain a record of transaction details of each said identification card that is read by said data interface mechanism.

13. The system of claim 1, wherein said host computer includes an alarm management system for monitoring alarms from at least one monitoring sub-system.

14. The system of claim 13, wherein said at least one monitoring sub-system is at least one system selected from the group consisting of: said data interface mechanism, a closed-circuit television (CCTV) system, a video motion-detection system, and a virtual fence system.

15. The system of claim 1, wherein said plurality of said unique set of encoded credentials is configured to be accessed only by an authorized individual.

16. The system of claim 1, wherein a copy of said database is located on said data interface mechanism, said copy periodically updated from said host computer when said host computer is on-line.

17. The system of claim 16, wherein said copy is configured to periodically update said database on said host computer when said host computer is on-line.

18. The system of claim 1, wherein said at least one encoded credential of said unique set of encoded credentials includes at least one item selected from the group consisting of: a fingerprint biometric marker, hand-dimension biometric marker, a retinal biometric marker, a voiceprint biometric marker, a facial biometric marker, a unique card serial number, a photograph, personal credentials, and a signature.

19. The system of claim 1, wherein said at least one base transmission mechanism is configured to transmit at least one item selected from the group consisting of: a data transmission, a voice transmission, an audio transmission, and a video transmission.

20. The system of claim 1, wherein said at least one base transmission mechanism is configured to operate using at least one selected from the group consisting of: telephone modem protocols, 802.11a LAN protocols, 802.11b LAN protocols, 802.11g LAN protocols, 802.15 PAN protocols, 802.16 WAN protocols, 802.16 MAN protocols, GPRS protocols, satellite protocols, cable protocols, two-way radio protocols, and direct cable protocols.

21. The system of claim 1, wherein said at least one base transmission mechanism includes at least one external network transmission mechanism.

22. The system of claim 21, wherein said at least one external network transmission mechanism includes at least one device selected from the group consisting of: a network connection, a radio transceiver, and a computer.

23. The system of claim 21, wherein said external network transmission mechanism is located remotely to said at least one base transmission mechanism.

24. The system of claim 1, wherein said at least one remote transmission mechanism is configured to operate using at least one selected from the group consisting of: telephone modem protocols, 802.11a LAN protocols, 802.11b LAN protocols, 802.11g LAN protocols, 802.15 PAN protocols, 802.16 WAN protocols, 802.16 MAN protocols, GPRS protocols, satellite protocols, cable protocols, two-way radio protocols, and direct cable protocols.

25. The system of claim 1, wherein said at least one remote transmission mechanism includes at least one external network transmission mechanism.

26. The system of claim 25, wherein said at least one external network transmission mechanism includes at least one device selected from the group consisting of: a network connection, a two-ray radio transceiver, and a computer.

27. The system of claim 25, wherein said external network transmission mechanism is located remotely to said at least one remote transmission mechanism.

28. The system of claim 1, the system further comprising:
(e) at least one power generation area for providing power to said host computer, and for recharging batteries and mobile devices.

29. The system of claim 1, the system further comprising:
(e) at least one virtual fence system for detecting physical breeches of the site perimeter.

30. The system of claim 1, the system further comprising:
(e) at least one virtual curtain system for detecting physical breeches of the site perimeter.

31. The system of claim 1, the system further comprising:
(e) at least one virtual dome system for detecting physical breeches of the site perimeter.

32. The system of claim 1, the system further comprising:
(e) at least one closed-circuit television (CCTV) system for detecting physical breeches and environmental conditions of the site perimeter.

33. The system of claim 32, wherein said at least one CCTV system includes a video motion-detection system.

34. The system of claim 1, the system further comprising:
(e) at least one enrollment area for enrolling the individual into said database of said host computer and issuing said identification card, said at least one enrollment area located remotely from said host computer, said at least one enrollment area communicationally connected to said at least one remote transmission mechanism.
